(19) United States
(12) Patent Application Publication
(10) Pub. No.: US 2017/0243305 A1
(43) Pub. Date: Aug. 24, 2017

(54) METHOD AND APPARATUS FOR RELAYING DISTRIBUTED ENERGY RESOURCE TRADING AND SYSTEM THEREOF

(71) Applicant: Electronics and Telecommunications Research Institute, Daejeon (KR)

(72) Inventors: Yoon-Sik YOO, Daejeon (KR); IL WOO LEE, Daejeon (KR)

(73) Assignee: Electronics and Telecommunications Research Institute, Daejeon (KR)

(21) Appl. No.: 15/436,418

(22) Filed: Feb. 17, 2017

(30) Foreign Application Priority Data
Feb. 19, 2016 (KR) 1020160019919
Nov. 8, 2016 (KR) 1020160148364

(51) Int. Cl. G06Q 50/06; G06Q 40/04

(52) U.S. Cl. CPC G06Q 50/06; G06Q 40/04

(57) ABSTRACT

Provided are an apparatus, method, and system for relaying trading of a distributed energy resource. A distributed energy resource trading relay method performed at a distributed energy resource trading relay apparatus may include receiving an auction request for a plurality of distributed energy resource chunks; calculating an availability probability and a trading probability of each of the auction-requested distributed energy resource chunks; assigning a weight to each of the distributed energy resource chunks based on the calculated availability probability and trading probability; and determining a purchaser having bid for distributed energy resource chunks corresponding to a greatest weight sum as a successful bidder in response to a plurality of purchasers bidding for the distributed energy resource chunks. Since a distributed energy resource may be divided based on a size available at a consumer and thereby traded, the availability of the distributed energy resource may be enhanced.

### CROSS-REFERENCE TO RELATED APPLICATION(S)

This application claims the priority benefit of Korean Patent Application No. 10-2016-0019919 filed on Feb. 19, 2016 and Korean Patent Application No. 10-2016-0148364 filed on Nov. 8, 2016 in the Korean Intellectual Property Office, the disclosures of which are incorporated herein by reference for all purposes.

### BACKGROUND

1. Field

At least one example embodiment relates to technology for relaying a trading of a distributed energy resource.

2. Description of Related Art

A variety of methods on trading a distributed energy resource have been studied. In general, a trading of a distributed energy resource may be performed by trading a single distributed energy resource through a power exchange. The trading availability of a distributed energy resource available for multiple purposes is limited.

To further effectively trade a distributed energy resource, there is a need to construct a distributed energy resource trading relay system to perform a multi-division of the distributed energy resource and to trade only a distributed energy resource required at an energy consumer. In particular, there is a need for a distributed energy resource trading relay system that enables different distributed energy resources distributed across a wide area to b effectively traded.

### SUMMARY

At least one example embodiments provides a technology that may perform a multi-division of and trade a distributed energy resource to be available at an energy consumer.

At least one example embodiment provides a technology that may perform a trading of a distributed energy resource based on an availability probability and a trading probability of the distributed energy resource.

According to an aspect of at least one example embodiment, there is provided a distributed energy resource trading relay method performed at a distributed energy resource trading relay apparatus, the method including receiving an auction request for a plurality of distributed energy resource chunks; calculating an availability probability and a trading probability of each of the auction-requested distributed energy resource chunks; assigning a weight to each of the distributed energy resource chunks based on the calculated availability probability and trading probability; and determining a purchaser having bid for distributed energy resource chunks corresponding to a greatest weight sum as a successful bidder in response to a plurality of purchasers bidding for the distributed energy resource chunks.

The plurality of distributed energy resource chunks may correspond to a distributed energy resource acquired by dividing at least one distributed energy resource in a time domain.

The availability probability may indicate a presence or an absence of a corresponding distributed energy resource chunk in a time domain or a presence probability thereof.

The calculating of the availability probability may include calculating the availability probability based on at least one of a current resource storage amount of a distributed energy resource facility that produces or stores the corresponding distributed energy resource chunk, an amount of power generated per hour, and a time allowed for power generation.

The calculating of the trading probability may include calculating a trading probability of a corresponding distributed energy resource using a Markov state transition probability.

According to an aspect of at least one example embodiment, there is provided a distributed energy resource trading relay apparatus including a processor and a memory. Instructions for relaying a distributed energy resource trading are stored in the memory, and the instructions include instructions that, in response to execution by the processor, control the processor to calculate an availability probability and a trading probability of each of a plurality of auction-requested distributed energy resource chunks, to assign a weight to each of the distributed energy resource chunks based on the calculated availability probability and trading probability, and to determine a purchaser having bid for distributed energy resource chunks corresponding to a greatest weight sum as a successful bidder in response to a plurality of purchasers bidding for the distributed energy resource chunks.

According to an aspect of at least one example embodiment, there is provided a distributed energy resource trading relay system including a plurality of seller terminals configured to divide a distributed energy resource into a plurality of distributed energy resource chunks, and to request auction for the divided distributed energy resource chunks; a plurality of purchaser terminals configured to bid for the distributed energy resource chunks; and a distributed energy resource trading relay apparatus configured to calculate an availability probability and a trading probability of each of the auction-requested distributed energy resource chunks, to assign a weight to each of the distributed energy resource chunks based on the calculated availability probability and trading probability, and to determine a purchaser terminal having bid for distributed energy resource chunks corresponding to a greatest weight sum as a successful bidder terminal among the plurality of purchaser terminals.

The purchaser terminal determined as the successful bidder terminal may be configured to provide incentive points to a seller terminal to be in proportion to an awarded time block.

The distributed energy resource trading relay apparatus may be configured to calculate the availability probability based on at least one of a current resource storage amount of a distributed energy resource facility that produces or stores the corresponding distributed energy resource chunk, an amount of power generated per hour, and a time allowed for power generation.

According to some example embodiments, since a distributed energy resource may be divided into sizes available at a consumer and thereby traded, the availability of the distributed energy resource may increase.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an example of a distributed energy resource trading relay system according to an example embodiment;

FIG. 2 is a flowchart illustrating a distributed energy resource trading relay method according to an example embodiment;

FIGS. 3A and 3B illustrate examples of calculating an availability probability for each distributed energy resource chunk according to an example embodiment;

FIG. 4 illustrates an example of calculating a trading probability for each distributed energy resource chunk using a Markov state transition probability according to an example embodiment;

FIGS. 5A and 5B illustrate examples of determining a successful bidder according to an example embodiment;

FIG. 6 illustrates an example of a bid result of a distributed energy resource chunk according to an example embodiment; and

FIG. 7 is a block diagram illustrating an example of a distributed energy resource trading relay apparatus according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

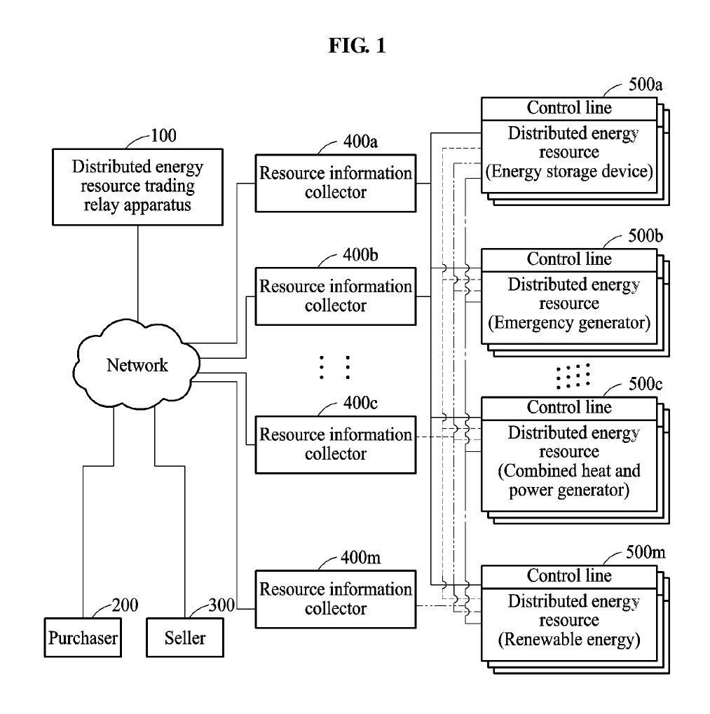

FIG. 1 is a diagram illustrating an example of a distributed energy resource trading relay system according to an example embodiment. Depending on example embodiments, at least one of the constituent elements of FIG. 1 may be omitted.

Referring to FIG. 1, the distributed energy resource trading relay system includes a distributed energy resource trading relay apparatus 100, at least one purchaser (or purchaser terminal) 200 configured to purchase a distributed energy resource, at least one seller (or seller terminal) 300 configured to sell the distributed energy resource, at least one resource information collector 400a, 400b, 400c, . . . , 400m, and at least one distributed energy resource 500a, 500b, 500c, . . . , 500m, which may be connected to each other over a network.

The seller 300 may request the distributed energy resource trading relay apparatus 100 to auction a distributed energy resource off. The seller 300 may request the distributed energy resource trading relay apparatus 100 to generate distributed energy resource chunks through multi-division of at least one distributed energy resource, and to auction the distributed energy resource chunks off. Here, distributed energy resource chunks may be a distributed energy resource acquired by dividing the at least one distributed energy resource in a time domain.

The distributed energy resource trading relay apparatus 100 may receive distributed energy resource information from the resource information collectors 400a, 400b, 400c, . . . , 400m, and may manage the distributed energy resource. In response to an auction request for a distributed energy resource chunk from at least one seller 300, the distributed energy resource trading relay apparatus 100 may post auction information about the requested distributed energy resource chunk at a website and the like, and may start the auction for the distributed energy resource chunk. The auction information may include at least one of a resource type, an available time, an available capacity, and the like. The distributed energy resource trading relay apparatus 100 may calculate an availability probability and a trading probability for each auction-requested distributed energy resource chunk. The availability probability and the trading probability for each distributed energy resource chunk will be described below with reference to the accompanying drawings. In response to a bid for the distributed energy resource chunk from at least one purchaser 200, the distributed energy resource trading relay apparatus 100 may determine a successful bidder based on an availability probability and a trading probability of the auction-requested distributed energy resource, and may notify the determined successful bidder for the awarded distributed energy resource.

The purchaser 200 may proceed with the bid for the distributed energy resource chunk based on the auction information posted at the website and the like. The purchaser 200, that is, the successful bidder that has successfully bid for the distributed energy resource chunk may be supplied with and use the corresponding distributed energy resource.

Each of the resource information collectors 400a, 400b, 400c, . . . , 400m may monitor a state of the distributed energy resource. Each of the resource information collectors 400a, 400b, 400c, . . . , 400m may monitor and manage a newly added or modified distributed energy resource. Each of the resource information collectors 400a, 400b, 400c, . . . , 400m may collect information about at least one of a current resource storage amount of a distributed energy resource facility that produces or stores the corresponding distributed energy resource chunk, an amount of power generated per hour, and a time allowed for power generation, and may provide the collected information to at least one of the distributed energy resource trading relay apparatus 100 and the seller 300. One of the resource information collectors 400a, 400b, 400c, . . . , 400m may be provided to correspond to a single seller 300. That is, the resource information collectors 400a, 400b, 400c, . . . , 400m and the at least one selector 300 may make a one-to-one correspondence.

The distributed energy resources 500a, 500b, 500c, . . . , 500m may be provided to the successful bidder determined through auction. The distributed energy resources 500a, 500b, 500c, . . . , 500m may be connected to the network over a control line. The control line may control supply of the distributed energy resources 500a, 500b, 500c, . . . , 500m. The control line may control the supply of the distributed energy resources 500a, 500b, 500c, . . . , 500m based on successful bidder information provided from the distributed energy resource trading relay apparatus 100 and information received from a separate server that controls the supply of the distributed energy resources 500a, 500b, 500c, . . . , 500m.

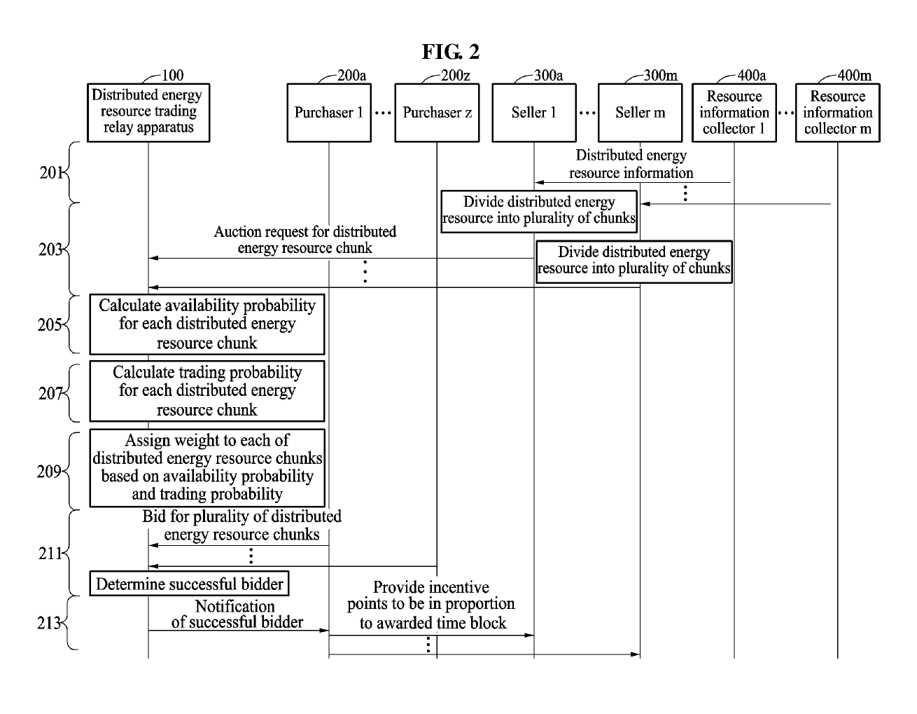

FIG. 2 is a flowchart illustrating a distributed energy resource trading relay method according to an example embodiment. Depending example embodiments, at least one of operations of FIG. 2 may be omitted.

In operation 201, the resource information collectors 400a, . . . , 400m may collect distributed energy resource information, and may provide the collected distributed energy resource information to sellers 300a, . . . , 300m. The distributed energy resource information may include information about at least one of a current resource storage amount of a distributed energy resource facility, an amount of power generated per hour, and a time allowed for power generation. Depending on example embodiments, the distributed energy resource information may be provided to the distributed energy resource trading relay apparatus 100.

In operation 203, the sellers 300a, . . . , 300m may generate a plurality of distributed energy resource chunks by dividing a distributed energy resource. For example, the sellers 300a, . . . , 300m may generate the plurality of distributed energy resource chunks by dividing the distributed energy resource based on a time unit. The sellers 300a, . . . , 300m may request the distributed energy resource trading relay apparatus 100 to start auction for the plurality of distributed energy resource chunks.

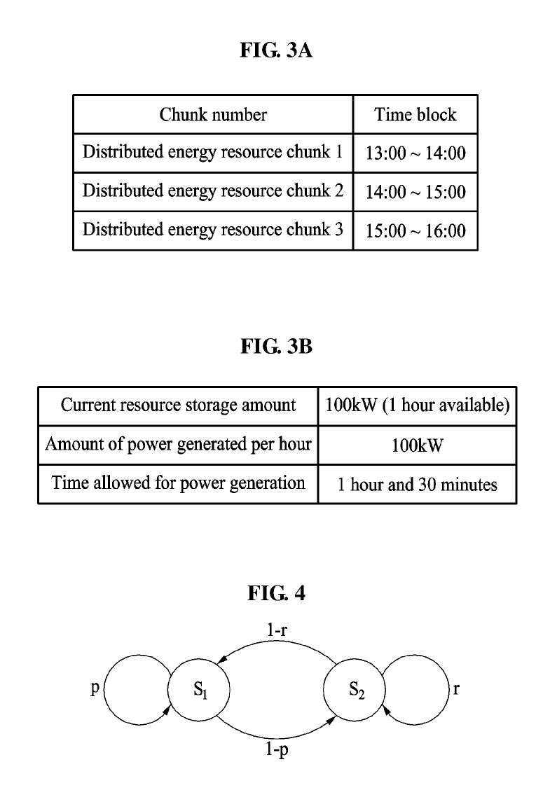

In operation 205, the distributed energy resource trading relay apparatus 100 may calculate an availability probability for each auction-requested distributed energy resource chunk. The availability probability for each distributed energy resource chunk may indicate a presence or an absence of the corresponding distributed energy resource chunk in a time domain or a presence probability thereof. The availability probability for each distributed energy resource chunk may be calculated based on the distributed energy resource information received from the resource information collectors 400a, . . . , 400m. It will be described with reference to FIGS. 3A and 3B.

FIGS. 3A and 3B illustrate examples of calculating an availability probability for each distributed energy resource chunk according to an example embodiment.

FIG. 3A shows an example in which a single distributed energy resource is divided into three distributed energy resource chunks, and FIG. 3B shows corresponding distributed energy resource information. In the example embodiment of FIGS. 3A and 3B, it is assumed that an auction request for the distributed energy resource chunks were made at 13:00 and the distributed energy resource is consumed by each 100 kW per hour.

A distributed energy resource chunk 1 corresponds to a one-hour time block from 13:00 to 14:00. A resource storage amount at 13:00 corresponding to a current point in time is 100 kW. Thus, an availability probability of the energy resource chunk 1 is determined as 1.

A distributed energy resource chunk 2 corresponds to a one-hour time block from 14:00 to 15:00. An energy resource available for the one-hour time block from 14:00 to 15:00 is not stored at 13:00 corresponding to the current point in time. However, 100 kW may be produced and stored during the one-hour time block from 13:00 to 14:00. Accordingly, an availability probability of the distributed energy resource chunk 2 may also be determined as 1.

A distributed energy resource chunk 3 corresponds to a one-hour time block from 15:00 to 16:00. An energy resource available for the one-hour time block from 15:00 to 16:00 is not stored at 13:00 corresponding to the current point in time. If 100 kW may be produced and stored during the one-hour time block from 14:00 to 15:00, an availability probability of the distributed energy resource chunk 3 may also be determined as 1. However, a time allowed for power generation at 13:00 corresponding to the current point in time is 1 hour and 30 minutes. Thus, the power generation is performed during only 30 minutes from 14:00 to 14:30 and 50 kw may be produced and stored. Accordingly, the availability probability of the distributed energy resource chunk 3 may be determined as 0.5.

Referring again to FIG. 2, in operation 207, the distributed energy resource trading relay apparatus 100 may calculate the trading probability for each auction-requested distributed energy resource chunk. The trading probability for each distributed energy resource chunk may be calculated using a Markov state transition probability. It will be described with reference to FIG. 4.

FIG. 4 illustrates an example of calculating a trading probability for each distributed energy resource chunk using a Markov state transition probability according to an example embodiment.

Referring to FIG. 4, a state S₁ denotes a state in which an energy trading has occurred and a state S₂ denotes a state in which the energy trading has not occurred. Also, p denotes a probability that the energy trading may occur in the state S₁, r denotes a probability that the energy trading may not occur in the state S₂, 1−r denotes a probability that the energy trading may occur in the state S₂, and 1−p denotes a probability that the energy trading may not occur in the state S₁. Configuring a transition probability matrix associated with a first energy trading using a state transition map of FIG. 4, the transition probability matrix may be represented as shown in Equation 1.

$$P = [ \begin{matrix}p & 1 - p \\ 1 - r & r\end{matrix} ] \qquad [ Equation 1 ]$$

A probability variation of a second energy trading may be represented as shown in Equation 2.

$$\begin{matrix}{P}^{2} = [ \begin{matrix}{p}^{2} + ( 1 - p ) ( 1 - r ) & p ( 1 - p ) + ( 1 - p ) r \\ p ( 1 - r ) + r ( 1 - r ) & {r}^{2} + ( 1 - p ) ( 1 - r )\end{matrix} ] \\ = [ \begin{matrix}{p}^{2} + ( 1 - p ) ( 1 - r ) & ( 1 - p ) ( p + r ) \\ ( 1 - r ) ( p + r ) & {r}^{2} + ( 1 - p ) ( 1 - r )\end{matrix} ]\end{matrix} \qquad [ Equation 2 ]$$

A probability variation of a third energy trading may be represented as shown in Equation 3.

$$\begin{matrix}{P}^{3} = [ \begin{matrix}\begin{matrix}{p}^{3} + ( 1 - p ) \\ ( 1 - r ) ( 2 p + r )\end{matrix} & \begin{matrix}( 1 - p ) \\ ( {p}^{2} + {r}^{2} + 2 pr - p - r + 1 )\end{matrix} \\ \begin{matrix}( 1 - r ) \\ ( \begin{matrix}{p}^{2} + {r}^{2} + \\ 2 pr - p - r + 1\end{matrix} )\end{matrix} & {r}^{3} + ( 1 - p ) ( 1 - r ) ( p + 2 r )\end{matrix} ] \\ = [ \begin{matrix}\begin{matrix}{p}^{3} + ( 1 - p ) \\ ( 1 - r ) ( 2 p + r )\end{matrix} & ( 1 - p ) \{ {( p + r )}^{2} - ( p + r ) + 1 \} \\ \begin{matrix}( 1 - r ) \\ \{ {( p + r )}^{2} - ( p + r ) + 1 \}\end{matrix} & {r}^{3} + ( 1 - p ) ( 1 - r ) ( 2 r + p )\end{matrix} ]\end{matrix} \qquad [ Equation 3 ]$$

A probability variation of a fourth energy trading may be represented as shown in Equation 4.

$$\begin{matrix}{P}^{4} = [ \begin{matrix}\begin{matrix}{p}^{4} + ( 1 - p ) ( 1 - r ) \\ \{ \begin{matrix}p ( 2 p + r ) + {( p + r )}^{2} - \\ ( p + r ) + 1\end{matrix} \}\end{matrix} & \begin{matrix}( 1 - p ) \\ \{ \begin{matrix}\begin{matrix}{p}^{3} + ( 1 - p ) \\ ( 1 - r ) ( 2 p + r ) +\end{matrix} \\ \begin{matrix}{r ( p + r )}^{2} - \\ r ( p + r ) + r\end{matrix}\end{matrix} \}\end{matrix} \\ \begin{matrix}( 1 - r ) \\ \{ \begin{matrix}{p ( p + r )}^{2} - p ( p + r ) + \\ \begin{matrix}p + {r}^{3 +} ( 1 - p ) \\ ( 1 - r ) ( 2 r + p )\end{matrix}\end{matrix} \}\end{matrix} & \begin{matrix}{r}^{4} + ( 1 - p ) ( 1 - r ) \\ \{ \begin{matrix}{( p + r )}^{2} - ( p + r ) + \\ 1 + r ( 2 r + p )\end{matrix} \}\end{matrix}\end{matrix} ] \\ = [ \begin{matrix}\begin{matrix}{p}^{4} + ( 1 - p ) ( 1 - r ) \\ \{ \begin{matrix}{p}^{2} + {( p + r )}^{2} + \\ ( p + r ) ( p - 1 ) + 1\end{matrix} \}\end{matrix} & \begin{matrix}( 1 - p ) \\ \{ \begin{matrix}{( p + r )}^{3} - 2 {( p + r )}^{2} + \\ 2 ( p + r )\end{matrix} \}\end{matrix} \\ \begin{matrix}( 1 - r ) \\ \{ \begin{matrix}{( p + r )}^{3} - \\ 2 {( p + r )}^{2} + 2 ( p + r )\end{matrix} \}\end{matrix} & \begin{matrix}{r}^{4} + ( 1 - p ) ( 1 - r ) \\ \{ \begin{matrix}r ( 2 r + p ) + {( p + r )}^{2} - \\ ( p + r ) + 1\end{matrix} \}\end{matrix}\end{matrix} ]\end{matrix} \qquad [ Equation 4 ]$$

Accordingly, a probability variation of an n^{th} energy trading may be represented as shown in Equation 5.

$${p}^{n} = [ \begin{matrix}\begin{matrix}{p}^{n} + ( 1 - p ) ( 1 - r ) \\ \{ \begin{matrix}p ( 2 p + r ) + {( p + r )}^{2} - \\ ( p + r ) + 1\end{matrix} \}\end{matrix} & \begin{matrix}( 1 - p ) \\ \{ \begin{matrix}\begin{matrix}{p}^{3} + ( 1 - p ) \\ ( 1 - r ) ( 2 p + r ) +\end{matrix} \\ \begin{matrix}{r ( p + r )}^{2} - \\ r ( p + r ) + r\end{matrix}\end{matrix} \}\end{matrix} \\ \begin{matrix}( 1 - r ) \\ \{ \begin{matrix}\begin{matrix}{p ( p + r )}^{2} - p \\ ( p + r ) + p + {r}^{3} +\end{matrix} \\ ( 1 - p ) ( 1 - r ) ( 2 r + p )\end{matrix} \}\end{matrix} & \begin{matrix}{r}^{n} + ( 1 - p ) ( 1 - r ) \\ \{ \begin{matrix}{( p + r )}^{2} - ( p + r ) + \\ 1 + r ( 2 r + p )\end{matrix} \}\end{matrix}\end{matrix} ] \qquad [ Equation 5 ]$$

Here, by replacing p(2p+r)+(p+r)²−(p+r)+1 with an enrichment function α, by replacing (p+r)²−2(p+r)+2 with an enrichment function β, and by replacing r(2r+p)+(p+r)²−(p+r)+1 with an enrichment function γ, it may be represented as shown in Equation 6.

$${P}^{n} = [ \begin{matrix}{p}^{n} + α ( 1 - p ) ( 1 - r ) & β ( 1 - p ) ( p + r ) \\ β ( 1 - r ) ( p + r ) & {r}^{n} + γ ( 1 - p ) ( 1 - r )\end{matrix} ] \qquad [ Equation 6 ]$$

Referring to Equation 6, if an energy trading is performed n times, a probability that a traded resource is traded again is pⁿ+α(1−p)(1−r), a probability that a traded resource is not traded is β(1−p)(p+r), and a probability that a non-traded resource is traded is β(1−r)(p+r).

Referring again to FIG. 2, in operation 209, the distributed energy resource trading relay apparatus 100 may assign a weight to each of the distributed energy resource chunks based on the calculated availability probability and trading probability. For example, the distributed energy resource trading relay apparatus 100 may sort the distributed energy resource chunks in descending order of a multiplication of the availability probability and the trading probability, and may assign a relatively high weight to each of the distributed energy resource chunks based on the sorted order.

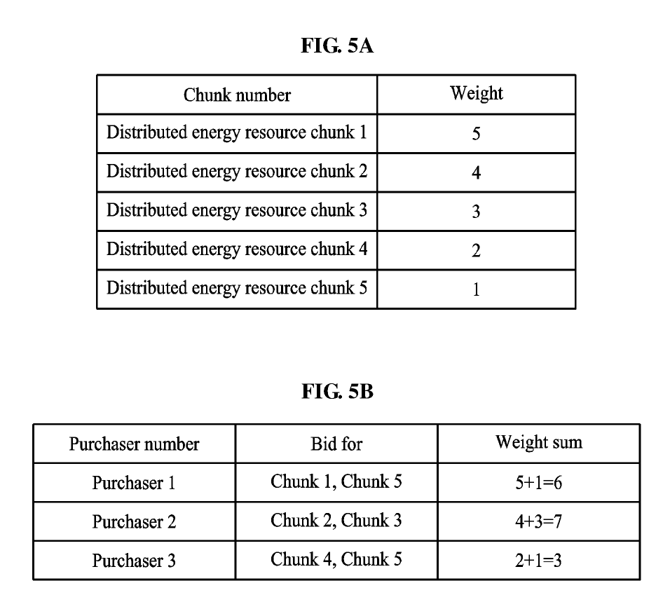

In operation 211, the distributed energy resource trading relay apparatus 100 may receive a bid for the distributed energy resource chunks from a plurality of purchasers 200a, . . . , 200z, and may determine a successful bidder based on the availability probability and the trading probability for each distributed energy resource chunk. Here, the distributed energy resource trading relay apparatus 100 may determine the successful bidder using a Borda count method. It will be described with reference to FIGS. 5A and 5B.

FIGS. 5A and 5B illustrate examples of determining a successful bidder according to an example embodiment.

In FIG. 5A, it is assumed that at least one distributed energy resource is divided into five distributed energy resource chunks, and a weight is assigned to each of the distributed energy resource chunks based on an availability probability and a trading probability for each distributed energy resource chunk. In FIG. 5B, it is assumed that three purchasers bid for distributed energy resource chunks.

Referring to FIGS. 5A and 5B, it can be known that a purchaser 1 has bid for a distributed energy resource chunk 1 (chunk 1) and a distributed energy resource chunk 5 (chunk 5), and a weight sum of the bid distributed energy resource chunks 1 and 5 is 6. Also, it can be known that a purchaser 2 has bid for a distributed energy resource chunk 2 (chunk 2) and a distributed energy resource chunk 3 (chunk 3), and a weight sum of the bid distributed energy resource chunks 2 and 3 is 7. Also, it can be known that a purchaser 3 has bid for a distributed energy resource chunk 4 (chunk 4) and the distributed energy resource chunk 5 and a weight sum of the bid distributed energy resource chunks 4 and 5 is 3.

That is, the bid of the purchaser 2 corresponds to a largest weight sum of bid distributed energy resource chunks and thus, the purchaser 2 may be determined as a successful bidder. The purchaser 3 having bid for the distributed energy resource chunks 4 and 5 that do not overlap the distributed energy resource chunks 2 and 3 of the purchaser 2 determined as the successful bidder may also be determined as the successful bidder.

Referring again to FIG. 2, in operation 213, the distributed energy resource trading relay apparatus 100 may notify the determined successful bidder that the bid for the corresponding distributed energy resource chunk is successful. The successful bidder may be provided with the bid distributed energy resource chunk. Meanwhile, the successful bidder may provide incentive points to a seller to be in proportion to an awarded time block. For example, if a distributed energy resource chunk corresponding to a one-hour time block is provided from a seller 1 and a distributed energy resource chunk corresponding to a two-hour time block is received from a seller 2, the successful bidder may provide a single incentive point to the seller 1 and may provide two incentive points to the seller 2. Depending on example embodiments, incentive points may be managed at the distributed energy resource trading relay apparatus 100. If the bid for the distributed energy resource chunk is successfully made, the distributed energy resource trading relay apparatus 100 may provide incentive points of the successful bidder to the seller. The incentive points may be used to assign a bid priority in response to an occurrence of a trading of another distributed energy resource.

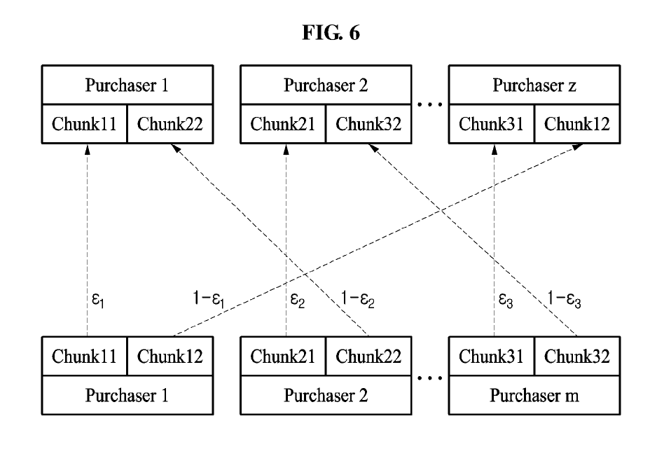

FIG. 6 illustrates an example of a bid result of a distributed energy resource chunk according to an example embodiment.

FIG. 6 illustrates an example of requesting auction in a state in which a seller 1 has divided a single distributed energy resource into two distributed energy resource chunks, for example, chunk 11 and chunk 12, in a time domain, a seller 2 has divided a single distributed energy resource into two distributed energy resource chunks, for example, chunk 21 and chunk 22, in the time domain, and a seller m has divided a single distributed energy resource into two distributed energy resource chunks, for example, chunk 31 and chunk 32, in the time domain.

According to the aforementioned auction process, a purchaser 1 is awarded chunk 11 for which auction is requested by the seller 1 and chunk 22 for which auction is requested by the seller 2, a purchaser 2 is awarded chunk 21 for which auction is requested by the seller 2 and chunk 32 for which auction is requested by the seller m, and a purchaser z is awarded chunk 31 for which auction is requested by the seller m and chunk 12 for which auction is requested by the seller 1.

In the example of FIG. 6, chunk 11 may be traded with the purchaser 1 at a probability of ε₁, and chunk 12 may be traded with a purchaser n at a probability of 1−ε₁. Here, a probability that a purchaser is awarded a desired distributed energy resource chunk in response to an n^{th} trading associated with the distributed energy resource chunk may be calculated based on a Markov state transition probability. For example, a probability that the purchaser 1 is awarded chunk 11 at the n^{th} trading is Πε₁pⁿ.

As described above, each of sellers may divide a single distributed energy resource into a plurality of distributed energy resource chunks and may request auction. Each of purchasers may bid for a desired distributed energy resource chunk and may use a desired amount of the distributed energy resource chunk. Accordingly, an efficient energy resource trading may be performed and the unnecessary use of an energy resource may be prevented.

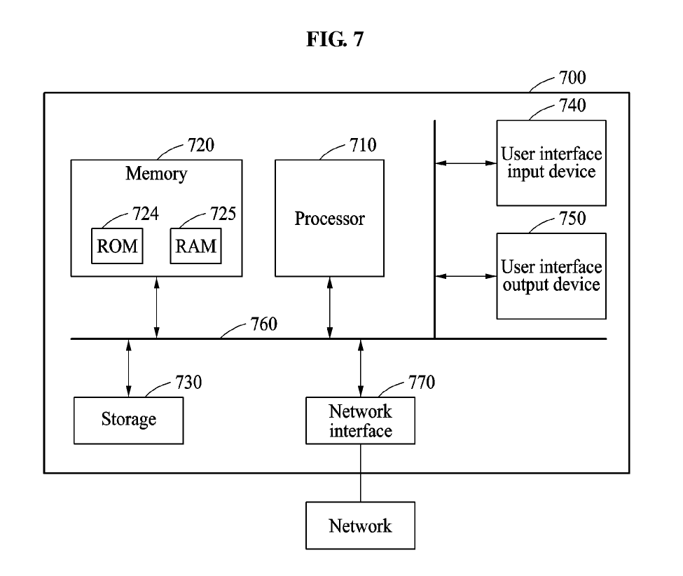

FIG. 7 is a block diagram illustrating an example of a distributed energy resource trading relay apparatus according to an example embodiment. Depending on example embodiments, at least one of constituent elements of FIG. 7 may be omitted.

Example embodiments may be configured as, for example, a non-transitory computer-readable medium within, for example, a computer system. Referring to FIG. 7, a computer system 700 may include at least one of at least one processor 710, a memory 720, a storage 730, a user interface input device 740, and a user interface output device 750. The constituent elements may communicate with each other through a bus 760. Also, the computer system 700 may include a network interface 770 for connection to a network. The processor 710 may be a central processing unit (CPU) or a semiconductor device configured to execute processing instructions stored in the memory 720 and/or the storage 730. The memory 720 and the storage 730 may include various types of volatile/non-volatile recording mediums. For example, the memory 720 may include read only memory (ROM) 724 and random access memory (RAM) 725.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A distributed energy resource trading relay method performed at a distributed energy resource trading relay apparatus, the method comprising:
receiving an auction request for a plurality of distributed energy resource chunks;
calculating an availability probability and a trading probability of each of the auction-requested distributed energy resource chunks;
assigning a weight to each of the distributed energy resource chunks based on the calculated availability probability and trading probability; and
determining a purchaser having bid for distributed energy resource chunks corresponding to a greatest weight sum as a successful bidder in response to a plurality of purchasers bidding for the distributed energy resource chunks.

2. The method of claim 1, wherein the plurality of distributed energy resource chunks corresponds to a distributed energy resource acquired by dividing at least one distributed energy resource in a time domain.

3. The method of claim 1, wherein the availability probability indicates a presence or an absence of a corresponding distributed energy resource chunk in a time domain or a presence probability thereof.

4. The method of claim 3, wherein the calculating of the availability probability comprises calculating the availability probability based on at least one of a current resource storage amount of a distributed energy resource facility that produces or stores the corresponding distributed energy resource chunk, an amount of power generated per hour, and a time allowed for power generation.

5. The method of claim 1, wherein the calculating of the trading probability comprises calculating a trading probability of a corresponding distributed energy resource using a Markov state transition probability.

6. A distributed energy resource trading relay apparatus comprising a processor and a memory, wherein instructions for relaying a distributed energy resource trading are stored in the memory, and
the instructions comprise instructions that, in response to execution by the processor, control the processor to calculate an availability probability and a trading probability of each of a plurality of auction-requested distributed energy resource chunks, to assign a weight to each of the distributed energy resource chunks based on the calculated availability probability and trading probability, and to determine a purchaser having bid for distributed energy resource chunks corresponding to a greatest weight sum as a successful bidder in response to a plurality of purchasers bidding for the distributed energy resource chunks.

7. The distributed energy resource trading relay apparatus of claim 6, wherein the plurality of distributed energy resource chunks corresponds to a distributed energy resource acquired by dividing at least one distributed energy resource in a time domain.

8. The distributed energy resource trading relay apparatus of claim 6, wherein the availability probability indicates a presence or an absence of a corresponding distributed energy resource in a time domain or a presence probability thereof.

9. The distributed energy resource trading relay apparatus of claim 8, wherein the instructions comprise instructions that control the processor to calculate the availability probability based on at least one of a current resource storage amount of a distributed energy resource facility that produces or stores the corresponding distributed energy resource chunk, an amount of power generated per hour, and a time allowed for power generation.

10. The distributed energy resource trading relay apparatus of claim 6, wherein the instructions comprise instructions that control the processor to calculate a trading probability of a corresponding distributed energy resource using a Markov state transition probability.

11. A distributed energy resource trading relay system comprising:
a plurality of seller terminals configured to divide a distributed energy resource into a plurality of distributed energy resource chunks, and to request auction for the divided distributed energy resource chunks;
a plurality of purchaser terminals configured to bid for the distributed energy resource chunks; and
a distributed energy resource trading relay apparatus configured to calculate an availability probability and a trading probability of each of the auction-requested distributed energy resource chunks, to assign a weight to each of the distributed energy resource chunks based on the calculated availability probability and trading probability, and to determine a purchaser terminal having bid for distributed energy resource chunks corresponding to a greatest weight sum as a successful bidder terminal among the plurality of purchaser terminals.

12. The distributed energy resource trading relay system of claim 11, wherein the purchaser terminal determined as the successful bidder terminal is configured to provide incentive points to a seller terminal to be in proportion to an awarded time block.

13. The distributed energy resource trading relay system of claim 11, wherein the plurality of distributed energy resource chunks corresponds to a distributed energy resource acquired by dividing at least one distributed energy resource in a time domain.

14. The distributed energy resource trading relay system of claim 11, wherein the availability probability indicates a presence or an absence of a corresponding distributed energy resource chunk in a time domain or a presence probability thereof.

15. The distributed energy resource trading relay system of claim 14, wherein the distributed energy resource trading relay apparatus is configured to calculate the availability probability based on at least one of a current resource storage amount of a distributed energy resource facility that produces or stores the corresponding distributed energy resource chunk, an amount of power generated per hour, and a time allowed for power generation.

16. The distributed energy resource trading relay system of claim 15, further comprising:
a resource information collector configured to collect information about at least one of the current resource storage amount of the distributed energy resource facility, the amount of power generated per hour, and the time allowed for power generation, and to provide the collected information to the distributed energy resource trading relay apparatus.

17. The distributed energy resource trading relay system of claim 11, wherein the distributed energy resource trading relay apparatus is configured to calculate a trading probability of a corresponding distributed energy resource using a Markov state transition probability.
